(19) United States
(12) Patent Application Publication
(10) Pub. No.: US 2006/0279633 A1
(43) Pub. Date: Dec. 14, 2006

(54) Method of evaluating motion picture display performance, inspection screen and system for evaluating motion picture display performance

(76) Inventor: Koichi Oka, Otsu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/436,759

(22) Filed: May 19, 2006

(30) Foreign Application Priority Data
May 20, 2005 (JP) 2005-148338

(51) Int. Cl. H04N 17/00

(52) U.S. Cl. 348/187

(57) ABSTRACT

A test image is scrolled on a screen of a display device subject to evaluation. A plurality of sample images that are created using the same test image and each indicate different motion picture display performance index values are prepared. The plurality of the sample images are displayed as still images in a condition that permits comparison with the scrolling test image. Then, a sample image that most resembles the pursuit captured test image is specified, and a motion picture display performance index value of the specified sample image is determined to be a motion picture display performance index value of the test image.

### BACKGROUND OF THE INVENTION

1. Field of the Invention

The present invention relates to a technique for evaluating motion picture display performance based on the motion of a picture displayed on a screen of a display device subject to evaluation.

2. Description of the Related Art

Evaluations of motion picture display performance are conducted by measuring the motion of a motion picture displayed on a screen of a display device such as Liquid Crystal Display (LCD), Cathode-ray tube (CRT) display, Plasma Display Panel (PDP), or Electroluminescence (EL) display.

A conventional method of such evaluations is a process in which patterns dividing the screen into left and right blocks whose grey levels are different from each other are scrolled on the screen, and a camera pursues the motion of the patterns and captures images thereof as static images. Simultaneously, with a display device that incurs small blur such as CRT or the like placed aside, a test pattern that has preliminarily been blurred to a certain extent is displayed at the same scroll velocity, which is captured as a static image. Then, the both are compared with each other to determine the degree of blur by visual observation. (Refer to J. Someya, Y. Igarashi “A Review of MPRT Measurement Method for Evaluating Motion Blur of LCDs” IDW′ 04 VHF6/LCT7-1)

In another evaluation method, a camera is adapted to pursue the motion of a picture in the manner of the eye ball and captures the picture as a static image, and the sharpness of the static image that has been captured is evaluated. In the case of a display device such as LCD with a long image-keeping time, in particular, the sharpness of the image deteriorates in the edges. The deterioration of the sharpness is digitized so as to be used as an index ( Refer to Japanese Patent Application Laid-Open (Kokai) No.2001-204049).

The foregoing evaluation method presented by J. Someya, Y. Igarashi requires a CRT display or the like besides the sample display.

In addition, because of the use of a test pattern that is easy to evaluate visually, reliability on whether a proper evaluation of the motion picture display performance can be made or not in cases where an actual motion picture is displayed is low.

The method disclosed in the foregoing Japanese Patent Application Laid-Open (Kokai) No. 2001-204049 merely puts emphasis on objective analysis of captured image profiles that appear on the display when a scrolling measuring pattern is captured by a camera.

A method of evaluating motion picture display performance which reflects motion picture display performance based on subjective perception of actual images by a human observer with good reproducibility has been awaited.

Therefore, it is a primary object of the present invention to provide a method of evaluating motion picture display performance, an inspection screen and a system for evaluating motion picture display performance capable of determining motion picture display performance index values of a display subject to evaluation using indexes leading to perceptional understanding of the degree of the speed of motion that can be displayed.

### SUMMARY OF THE INVENTON

A method of evaluating motion picture display performance according to the present invention is described as follows: a test image is scrolled and the scrolling image is displayed on a screen of a display device subject to evaluation. Meanwhile, a plurality of sample images that are created by using the test image and each indicate different motion picture display performance index values are prepared, and the plurality of sample images are displayed as still images in a condition that permits comparison with the test image being scrolled. Then, a sample image that most resembles the pursuit captured (pursued and captured) test image is specified. A motion picture display performance index value of the specified sample image is determined to be a motion picture display performance index value of the test image.

By this evaluation method, after comparing the scrolling test image with the plurality of sample images, when the sample image that most resembles the test image is specified, a motion picture display performance index value of the sample image can be determined to be a motion picture display performance index value of the display device subject to evaluation (also referred to as “target display device”). Accordingly, motion picture display performance index values of the display device subject to evaluation can be determined through a simple procedure.

The test image is preferably an image that includes a specific character or symbol for facilitating blur evaluation. In particular, an image with a simple figure without halftones is preferable so that the degree of blur can be observed easily.

The foregoing sample images can be created by addition of the test image while shifting the test image a predetermined number of times by a unit pixel distance per 1 frame, or a distance corresponding to the display resolution of the display device.

The predetermined number of times N of addition of the test image is obtained by dividing the product of a time EBET corresponding to the motion picture display performance index value, a frame frequency f and a scroll velocity v by a unit pixel distanceΔ, where the frame frequency of the screen and scroll velocity per 1 frame are represented by f and v, respectively. The sample images can be created automatically by such a simple processing.

An inspection screen according to the present invention is a screen for implementing the method of evaluating motion picture display performance, which comprises a test image scrolling on a screen of a display device subject to evaluation and a plurality of sample images that are created based upon the test image and each indicate different motion picture display performance index values, both of which are displayed within the same frame in a condition that permits simultaneous comparison with each other.

A human observer observing this inspection screen compares the plurality of sample images with the test image scrolling on the screen, and specifies a sample image whose degree of blur is closest to that of the test image. This allows an index value for accurately determining the motion picture display performance of the target display device to be obtained easily.

A method of evaluating motion picture display performance according to the present invention comprises the following steps of: preparing an image and a plurality of sample images that are created based upon the image and each indicate different motion picture display performance index values; creating a test image by pursuit capturing the image while scrolling the image on a screen of a display device subject to evaluation; performing computation of correlations between the plurality of sample images and the test image to determine correlation values; specifying a sample image where the correlation value is maximum; and determining a motion picture display performance index value of the specified sample image to be a motion picture display performance index value of the display device subject to evaluation.

In this method, instead of displaying a test image on the screen of the target display device while scrolling the test image, a scrolling image is pursuit captured so as to be employed as the test image. In addition, in order to specify a sample image that most resembles the test image, instead of comparing the test image with sample images by visual observation, computation of correlations is used. Accordingly, a motion picture display performance index value of the target display device can be determined accurately and rapidly solely by image processing without depending on human visual perception.

The foregoing sample images may be created by addition of a predetermined number of the image while shifting the image by a unit pixel distance per 1 frame or a distance corresponding to the display resolution of the display device, which predetermined number is determined by dividing the product of a time corresponding to the motion picture display performance index value, a frame frequency f and a scroll velocity v by a unit pixel distance, where the frame frequency of the screen and scroll velocity per 1 frame are represented by f and v, respectively,. The sample images can be created automatically by such a simple processing.

The correlation values can be determined based upon a value obtained by integrating the difference in luminance between the both images over an overlapping area between the both images.

A system for evaluating motion picture display performance according to the present invention comprises a first storage section for storing a plurality of sample images that are created based upon an image and each indicate different motion picture display performance index values; a second storage section for creating a test image by pursuit capturing the image while the image is scrolled on a screen of a display device subject to evaluation and storing the test image; a computation section for performing computation of correlations between the plurality of sample images stored in the first storage section and the test image that is pursuit captured and stored in the second storage section to determine correlation values; and an output section for specifying a sample image where the correlation value is maximum.

These and other advantages, features and effects of the present invention will be made apparent by the following description of preferred embodiments with reference to the accompanying drawings.

### BRIEF DESCRIPTION OF THE DRAWINGS

FIG. 1 is a diagram of an inspection screen of a display device subject to evaluation according to the present invention.

FIG. 2 shows correspondences between blur indexes and images of a sample letter pattern.

FIG. 3 shows an example of variations of test letter pattern and sample letter pattern where the relationship in lightness between the letter pattern and the background is varied in several ways.

FIG. 4 is a block diagram showing the configuration of a system for pursuit capturing images.

FIG. 5 is an optical path diagram showing the positional relationship between a detector plane 31 of a camera 3 and a display screen 5 of the display device subject to evaluation.

FIG. 6 is a functional block diagram showing a system for evaluating motion picture display performance according to the present invention.

FIG. 7 is a flowchart illustrating a motion picture display performance evaluation procedure according to the present invention.

FIG. 8 is a graph for illustration of a method of creating a sample image.

FIG. 9 is a graph for illustration of determination of correlation values.

### DETAILED DESCRIPTION OF PREFERRED EMBODIMENTS

Hereinafter, specific embodiments of the present invention will be described with reference to the accompanying drawings. In the embodiments below, EBET (Extended Blurred Edge Time) is used as a motion picture display performance index of the display device subject to evaluation.

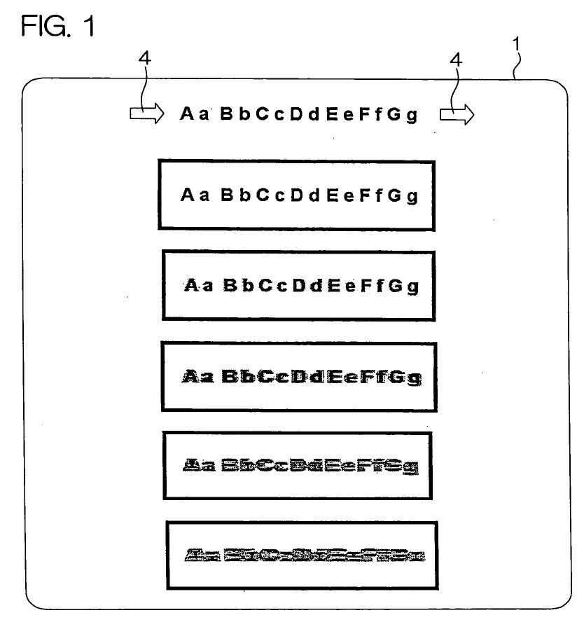

FIG. 1 is a diagram showing an inspection screen 1 of a display device subject to evaluation.

A test letter pattern “AaBbCc . . . ” that is repeatedly scrolling is depicted in the uppermost stage of the drawing. The white arrows 4 indicate the direction in which the test letter pattern scrolls.

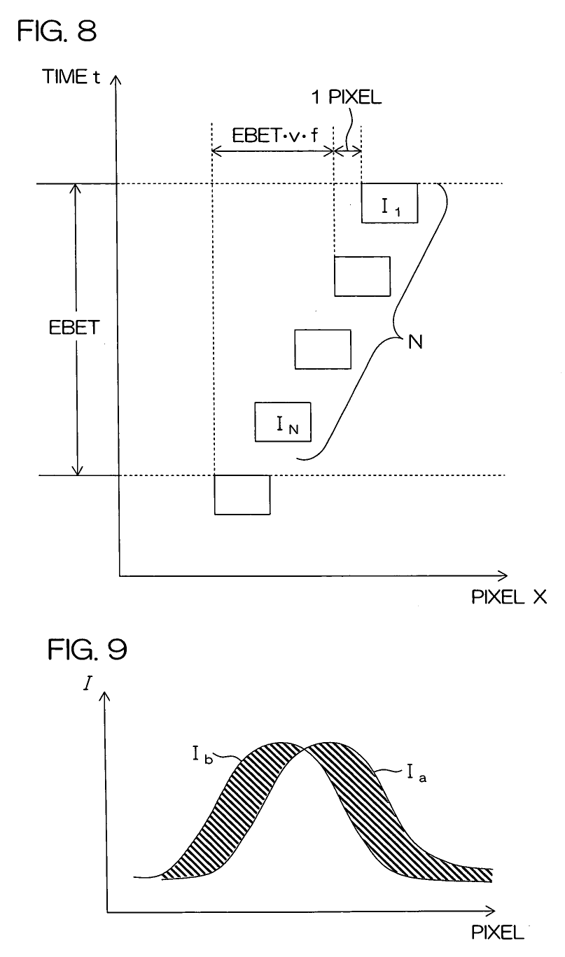

In the lower part of the drawing, a plurality of the letter patterns “AaBbCc . . . ” made by using the same font type and size, which represent different levels of blur (Blur Index), are shown over 5 stages as still images. The method of creating these sample letter patterns will be later described in detail with reference to FIG. 8.

The letter pattern “AaBbCc . . . ” in the uppermost stage of the foregoing five stages indicates a sample letter pattern representing the minimum blur index. As the stage lowers, the blur index of the sample letter pattern becomes greater.

Meanwhile, although the inspection screen 1 in which the test letter pattern scrolls and the screen for displaying the sample, letter patterns as still images may not necessarily be the screen of the same display device, displaying the test letter pattern and sample letter patterns on the same screen 1 allows the display conditions (such as lightness of the background) of the display device subject to evaluation to be consistent, so that evaluation accuracy is improved. Hereinafter, the discussion will proceed assuming that the same screen is used.

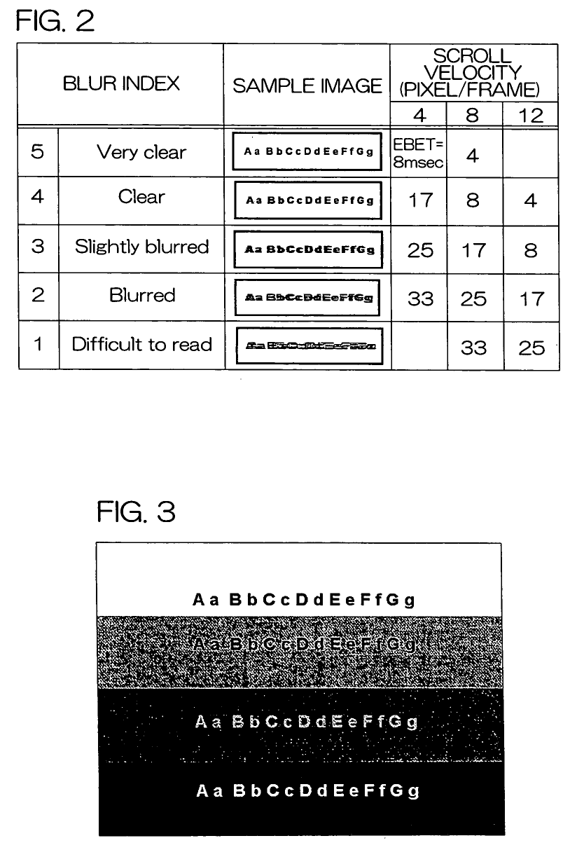

FIG. 2 shows correspondences between sample letter patterns and blur indexes. While the contents of FIG. 2 are preliminarily stored as data, they may be printed on paper, or displayed as still images on a sub-window of the same screen of the display device subject to evaluation or on the screen of another display device according to need.

In FIG. 2, the blur indexes are graded into 5 levels from “Difficult to Read” to “Very Clear”, and sample letter patterns corresponding to the respective blur indexes of the five levels are shown. The sample letter patterns incur an pattern profile tailing phenomenon of dropping from a lightness level of character to a lightness level of background, which corresponds to the blur indexes.

In addition, EBET (Extended Blurred Edge Time) values corresponding to the foregoing blur indexes are shown in FIG. 2. This EBET is related to the scroll velocity indicative of how many pixels per frame an image moves.

As shown in FIG. 2, even when the blur indexes appear to be the same, comparison of an evaluation made when the letter pattern scrolls at a high scroll velocity with an evaluation made when the letter pattern scrolls at a low scroll velocity shows that the former outputs better (i.e., smaller) EBET than the latter. Furthermore, when the same display device is used for the evaluation (i.e., when the EBET is the same), the greater the scroll velocity, the higher the blur index.

For example, when the blur index is evaluated as level 4, “Clear”, at a scroll velocity of 4 pixel/frame, the EBET of the target display device can be determined as 17 msec. When the blur index is determined as level 2, “Blurred”, at a scroll velocity of 12 pixel/frame, the EBET of the target display can be determined also as 17 msec.

During an observation of the inspection screen 1 of the target display device in FIG. 1, one or a plural number of observers compare the blur level of the test letter pattern scrolling at a predetermined scroll velocity on the inspection screen 1 with the blur levels of the sample letter patterns listed in the lower part to specify the sample letter pattern that most resembles the scrolling test letter pattern.

The foregoing observation is preferably repeated several times by varying the scroll velocity. By varying the scroll velocity, more data can be collected and more accurate evaluations can be made.

The results of observations by an observer are accumulated as observation data. The observation data are given to an evaluator, who may be the same person or another person, and the evaluator determines the EBET of the target display device by applying the specified blur level and the scrolling velocity to the table showing a list of correspondences in FIG. 2. When there are data taken at different scroll velocities, an average of EBET values determined at the respective scroll velocities is calculated which is determined to be the EBET of the target display device. Furthermore, when there are data taken by a plural number of observers, an average of EBET values determined for the respective data is calculated, which is determined to be the EBET of the target display device.

This makes it possible to determine EBET of the target display-device precisely through a simple procedure.

Alternatively, the list of correspondences in FIG. 2 may be written as a program, and observation data are entered in the computer to be processed by the computer instead of an evaluator so that EBET of the target display device can be determined automatically.

In the foregoing description, the test letter pattern and sample letter patterns are displayed in black characters with a white background. However, the relationship in lightness is not limited to the foregoing example, but the relationship between the characters and background may be determined so that results most accurately reflecting the observer's observations can be obtained.

FIG. 3 shows an example in which the relationship in lightness between a character and a background of the test letter pattern and sample letter pattern is varied in several ways. A black letter pattern displayed on a screen with a white background is shown in the top column, and the gray scale of the background decreases and the lightness increases as the location moves downward. The lowermost stage shows a white letter pattern displayed on a screen with a black background.

In the foregoing embodiment, the test letter pattern and sample letter patterns are displayed on the same screen of the target display device so as to be compared with each other. However, as already mentioned, the sample letter patterns may be displayed on another screen close to the observer. In addition, instead of displaying the sample letter patterns on a display screen, they may be printed on paper or the like so that the observer compares the test letter pattern displayed on the screen of the target display device with the sample letter patterns printed on paper.

In addition, while English characters are used for the letter pattern described so far, the present invention is not limited to such characters, but a number string, Chinese characters or phonetic syllabaries, or objects other than characters such as symbols or marks may also be used. However, in order to facilitate determination of blur indexes, objects with simple figures with no halftones are preferably used(for example, in the case of Chinese characters, gothic style is preferred to Ming style). This is because, when a blur index is determined by observing the pattern profile tailing phenomenon of dropping from a lightness level of character to a lightness level of background, an object with a simple figure permits easy observation of this pattern profile tailing phenomenon.

In addition, while blur index is graded into 5 levels, it is not limited to five levels, but may be graded into, for example, 3 levels. In that case, the descriptions will be “Clear”, “Normal” and “Difficult to Read”. Evaluations by 5 to 6 levels are possible by human perceptions.

Now another embodiment of the present invention in which a test image is prepared by pursuing and capturing a moving image by a camera, and then resemblance between the test image and the sample image is evaluated by image processing is described.

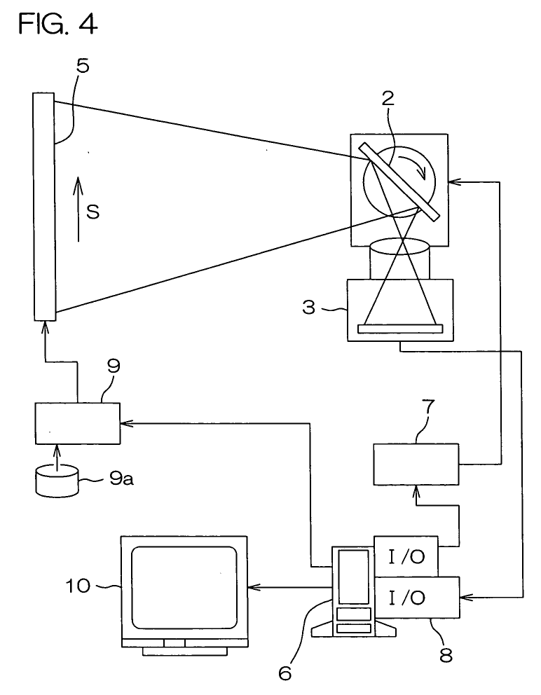

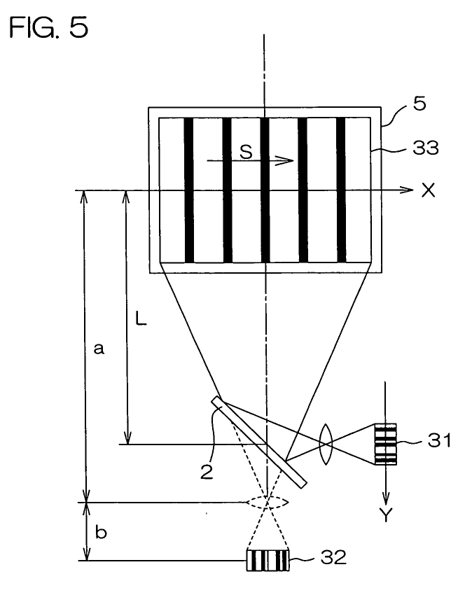

FIG. 4 is a block diagram illustrating the configuration of an image capturing system (which functions as a system for evaluating motion picture display performance) for pursuing and capturing (pursuit capturing) images.

The image capturing system includes a galvanometer mirror 2, a camera 3 that captures images of a screen 5 of a display device subject to evaluation through the galvanometer mirror 2.

The galvanometer mirror 2 comprises a mirror attached to the rotation axis of a permanent magnet that is rotatably disposed in a magnetic field generated when an electric current flows through a coil, and the mirror is capable of rotating smoothly and speedily.

The camera 3 has a field of view covering a part of or the entire screen 5 of the target display device. The galvanometer mirror 2 is disposed between the camera 3 and the screen 5 so that the field of view of the camera 3 can move in a one-dimensional direction (hereinafter referred to as the “scrolling direction”, which is denoted by “S” in FIG. 4) in response to rotation of the galvanometer mirror 2.

A rotary drive signal is transmitted from a computer control section 6 to the galvanometer mirror 2 through a galvanometer mirror drive controller 7.

An image signal received by the camera 3 is fetched into the computer control section 6 through an image capturing I/O board 8.

Meanwhile, instead of the arrangement where the galvanometer mirror 2 and the camera 3 are provided separately, a camera such as a lightweight digital camera itself may be situated on a rotary table so that it is rotationally driven by a rotary drive motor.

A display control signal for selecting a display screen 5 is transmitted from the computer control section 6 to an image signal generator 9 which, based on the display control signal, provides an image signal (stored in an image memory 9a) for displaying a motion picture to the target display device.

In addition, a liquid crystal monitor 10 is connected to the computer control section 6.

FIG. 5 is an optical path diagram illustrating a positional relationship between a detector plane 31 of the camera 3 and a screen 5 of the target display device.

Light from the field of view 33 of the camera 3 on the screen 5 is reflected at the galvanometer mirror 2 to be incident on the lens of the camera 3 and is detected at the detector plane 31 of the camera 3. A mirror image 32 of the detector plane 31 of the camera 3 is drawn by dashed lines on the rear side of the galvanometer mirror 2.

Let the distance along the optical path between the display device subject to evaluation and the galvanometer mirror 2 be represented by L. Let the distance along the optical path between the display device subject to evaluation and the lens be represented by a, and the distance from the lens to the detector plane 31 be represented by b. If a focal length f of the lens is known, the relationship between a and b can be found by the following equation:
1/f=1/a+1/b

Assume that a coordinate of the screen 5 of the display device subject to evaluation in the scrolling direction is X, and that a coordinate of the detector plane 31 of the camera 3 in the scrolling direction is Y. Set X0, the origin of X, at the center of the screen of the display device subject to evaluation, and set Y0, the origin of Y, at the point corresponding to X0. If a magnification of the lens of the camera 3 is M,
Y=MX
is satisfied.
The magnification M is expressed using the aforesaid a and b as follows:
M=−b/a

If the galvanometer mirror 2 is rotated by an angleφ, the corresponding position on the screen 5 of the display device subject to evaluation deviates with respect to the rotation axis of the galvanometer mirror 2 by an angle of 2φ. The coordinate X on the screen 5 of the display device subject to evaluation that corresponds to the angle 2φis expressed as follows:
X=L tan 2φ
A modification of the equation above gives the following equation:
φ=arctan (X/L)/2

The equation [X=L tan 2φ] is differentiated by time to give the following equation:
V=2L ω cos⁻² (2φ)
where v represents moving velocity of the field of view 33 on the screen, and ω represents rotary angular velocity of the galvanometer mirror (ω=dφ/dt).

Ifφis a minute angle, cos² (2ω)→1 can be assumed, therefore the equation above can be expressed as:
ω=v/2L
Thus, it can be assumed that the moving velocity v of the field of view 33 on the screen is proportional to the rotary angular velocity ω of the galvanometer mirror.

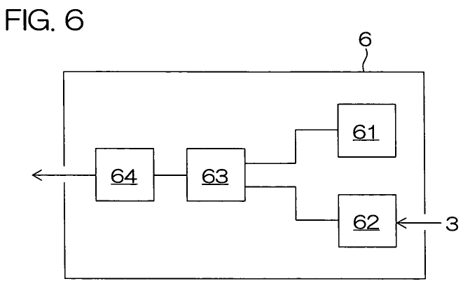

The structure of a system for evaluating motion picture display performance according to the present invention will now be described referring to FIG. 6. The system for evaluating motion picture display performance is realized as a processing function of the computer control section 6.

FIG. 6 is a functional block diagram showing a system for evaluating motion picture display performance.

The system for evaluating motion picture display performance includes a first storage section 61 for storing a plurality of sample images that are created based upon images stored in an image memory 9a and indicate different motion picture display performance index values. Here, the “image” does not need to be an object with a simple figure without halftones unlike the foregoing embodiment. This is because, as later described, evaluations are not made by visual observations but by determining correlations by means of software processing. Accordingly, the image may be a photograph or an actual scene of a movie, and of course, may be an image with a simple figure.

The method for obtaining sample images based upon the aforementioned image will be described later.

In addition, the system for evaluating motion picture display performance includes a second storage section 62 for storing a test image which is obtained by pursuit capturing an image scrolling on the screen of the target display device by the camera 3.

Furthermore, the system for evaluating motion picture display performance includes a computation section 63 for determining correlation values by computation of correlations between a plurality of the sample images stored in the first storage section 61 and the test image stored in the second storage section 62, and output section 64 for specifying a sample image where the correlation value is maximum.

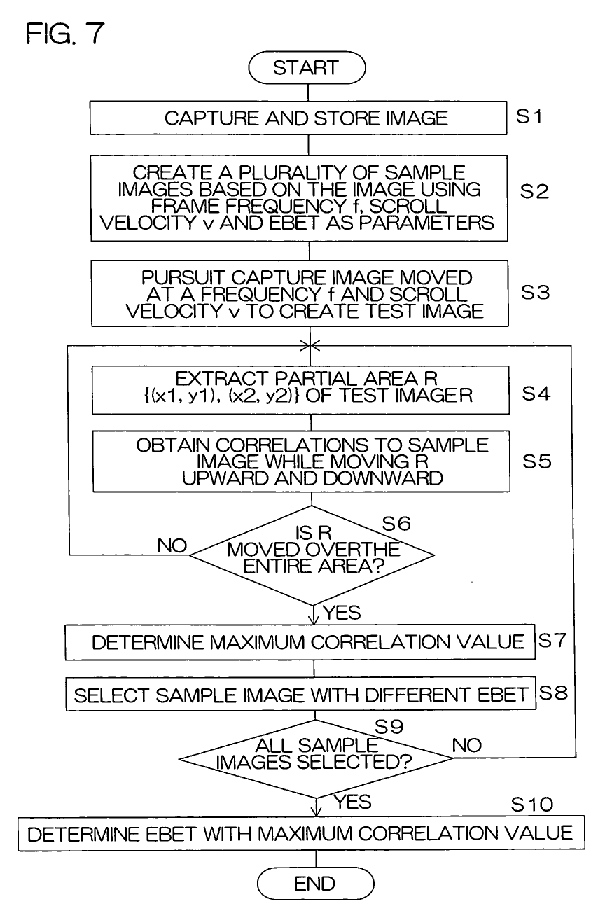

Now, referring to FIG. 7, a procedure of evaluating motion picture display performance with use of the system for evaluating motion picture display performance according to the present invention is described.

The computer control section 6 captures an image displayed as a still image on the display screen 5 of the target display device without scanning (step S1). Meanwhile, certain image data may be used as they are instead of actually capturing an image.

Then, a plurality of sample images with parameters including frame frequency f, scroll velocity v, and EBET are created based on the captured image (step S2). These sample images are stored in the first storage section 61.

A process of creating the sample images is described using FIG. 8. The horizontal axis of FIG. 8 represents a pixel x along the scrolling direction, the vertical axis represents time t. While 1 frame of image is sifted in the scrolling direction by 1 pixel per 1 frame time, N frames of images are created, intending that the relationship between N and EBET satisfies the following equation:
N=f·EBET˜v/Δ
where Δ represents a distance per pixel of the display device.

By adding the luminances of these images while shifting each of them by 1 pixel per 1 frame, sample images corresponding to the aforementioned EBET, frame frequency f and scroll velocity v can be obtained.

This is expressed by a formula in the following way. When the luminances of N frames of images are represented by I1, I2 . . . , IN, the luminance of a sample image is expressed as follows:
{I1+I2(Δ)+. . . +IN(NΔ)}/N
where N represents the number of pixels shifted spatially.

Averaging may be performed by assigning weights to the N frames of images. When the weight of the first image is represented by α1, the weight of the second image is represented byα2, and the weight of the Nth image is represented by αN, the luminance of the sample image is expressed as follows:
α1I1+α2I2(Δ)+. . . +αNIN(NΔ)
provided that α1+α2+. . . +αN=1. Determining this weight so as to be inversely proportional to the response speed of the display device approximates the visually perceived real images on the display device.

A plurality of sample images are created by varying the values of EBET, frame frequency f, and scroll velocity v, and stored.

Subsequently, while the image captured in the foregoing step S1 is displayed on the display screen 5 of the target display device and scrolled, the image is pursuit captured by the camera 3 with the galvanometer mirror 2 being rotated at a certain visual angular velocity (step S3). The image that has been pursuit captured is referred to as “test image”. The aperture of the camera 3 is assumed to be open during the rotation of the galvanometer mirror 2. The obtained test image is stored in the second storage section 62.

Subsequently, the computation section 63 extracts an image of a partial area R whose diagonal line runs from a point (x1, y1) to a point (x2, y2) of the test image (step S4). Here, x represents the horizontal axis and y represents the vertical axis of the test image. It is assumed that the value x2−x1 is a constant value, and the value y2−y1 is also a constant value. The center coordinates of the partial area R is expressed as (x0, y0).
x0=(x2+x1)/2
y0=(y2+y1)/2

While the partial area R is moved upward, downward, leftward and rightward, correlations to the plurality of sample images corresponding to the respective EBET values are determined (step S5). Here, while the sample images are functions of EBET, frame frequency f and scroll velocity v, the frame frequency f is a value that matches the frame frequency of the target display device. The scroll velocity v is a scroll velocity v at which the camera 3 pursuit captures the image.

Here, how to find a correlation value is described. FIG. 9 is a graph with a vertical axis representing luminance I of two images a, b and a horizontal axis representing pixel. Let the luminance of the image a be represented by Ia, and the luminance of the image b be represented by Ib. The second power of the difference between Ia and Ib (Ia−Ib)² is integrated over the overlapping pixel area, the square root of which is determined to be residual C.
C=√{Σ(Ia−Ib)²}

Correlation value is defined as the reciprocal of the residual C:
correlation value=1/C

Needless to add, determination of correlation values is accomplished not only by the foregoing process, but may be accomplished by many other known mathematical methodologies.

After the partial area R is moved over the entire area of the test image (step S6), the center coordinates (x0,y0) of the partial area R where the correlation value is maximum are specified (step S7).

Subsequently, after selection of a sample image with a different EBET (step S8), correlation values are determined by performing the processing from step S4 to step S7 again.

After the correlation values of all the sample images are determined (step S9), the EBET with the maximum correlation value is specified (step S10). This EBET is outputted from the output section 64.

By the processing described so far, the EBET of the test image is determined by image processing of the computer. Motion picture display performance index values of the target display device can be determined accurately and rapidly not by comparison with sample images based on visual observations but solely by image processing without depending on visual perception of human.

While specific embodiments of the present invention have been heretofore described, implementation of the present invention is not limited to the foregoing embodiments. For example, when there are a plurality of parameters for blur, or a parameter for image quality degradation, each of the parameters can be determined by the nonlinear least square method for maximizing correlation. In addition, the foregoing residual C or the correlation values may also be blur indexes.

1. A method of evaluating motion picture display performance for determining motion picture display performance based upon motion of an image displayed on a display device subject to evaluation, which comprises the following steps (a)-(e):
(a) preparing a plurality of sample images that are created-based upon a test image and each indicate different motion picture display performance index values;
(b) scrolling the test image on a screen of the display device subject to evaluation;
(c) displaying still images of the plurality of sample images in a condition that permits comparison with the test image that is scrolling;
(d) specifying a sample image most resembling the test image that is scrolling; and
(e) determining a motion picture display performance index value of the specified sample image to be a motion picture display performance index value of the display device subject to evaluation.

2. The method of evaluating motion picture display performance according to claim 1, wherein the test image is an image including a specific character or a symbol for blur evaluation.

3. The method of evaluation motion picture display performance according to claim 1, wherein the sample images in step (a) are created by addition of the test image while shifting the test image a predetermined number of times by a unit pixel distance per 1 frame, or a distance corresponding to the display resolution of the display device.

4. The method of evaluation motion picture display performance according to claim 3, wherein the predetermined number of times N the test image is added is obtained by dividing the product of a time EBET corresponding to a motion picture display performance index value, a frame frequency f and a scroll velocity v by a unit pixel distance, where the frame frequency of the screen and scroll velocity per 1 frame are represented by f and v, respectively.

5. An inspection screen of a display device subject to evaluation for implementing the method of evaluating motion picture display performance according to claim 1, which comprises a test image scrolling on a screen of a display device subject to evaluation and
a plurality of sample images that are created based upon the test image and each indicate different motion picture display performance index values, which are displayed within the same frame in a condition that permits simultaneous comparison with each other.

6. A method of evaluating motion picture display performance for determining motion picture display performance based upon motion of an image displayed on a display device subject to evaluation, which comprises the following steps (a)-(e):
(a) preparing an image and a plurality of sample images that are created based upon the image and each indicate different motion picture display performance index values;
(b) creating a test image by pursuit capturing the image while scrolling the image on a screen of a display device subject to evaluation;
(c) performing computation of correlations between the plurality of sample images and the test image to determine correlation values;
(d) specifying a sample image where a correlation value is maximum; and
(e) determining a motion picture display performance index value of the specified sample image to be a motion picture display performance index value of the display device subject to evaluation.

7. The method of evaluating motion picture display performance according to claim 6, wherein the sample images in step (a) are created by addition of the image while shifting the image a predetermined number of times by a unit pixel distance per 1 frame, or a distance corresponding to the display resolution of the display device.

8. The method of evaluating motion picture display performance according to claim 7, wherein the predetermined number of times N the image is added is obtained by dividing the product of a time EBET corresponding to a motion picture display performance index value, a frame frequency f and a scroll velocity v by a unit pixel distanceΔ, where the frame frequency of the screen and scroll velocity per 1 frame are represented by f and v, respectively.

9. The method of evaluating motion picture display performance according to claim 6, wherein the computation of correlations in the step (c) is based on a value obtained by integrating the difference in luminance between the both images over an overlapping area between the both images.

10. A system for evaluating motion picture display performance for determining motion picture display performance based upon motion of an image displayed on a display device subject to evaluation, which comprises the following elements (A)-(D):
(A) a first storage section for storing a plurality of sample images that are created based upon an image and each indicate different motion picture display performance index values;
(B) a second storage section for creating a test image by pursuit capturing the image while scrolling the image on a screen of a display device subject to evaluation and storing the test image;
(C) a computation section for performing computation of correlations between the plurality of sample images stored in the first storage section and the test image that is pursuit captured and stored in the second storage section to determine correlation values; and
(D) an output section for specifying a sample image where the correlation value is maximum.
